(19) United States
(12) Patent Application Publication
(10) Pub. No.: US 2016/0283883 A1
(43) Pub. Date: Sep. 29, 2016

(54) SELECTING A TASK OR A SOLUTION

(71) Applicant: HEWLETT PACKARD ENTERPRISE DEVELOPMENT LP, Houston, TX (US)

(72) Inventors: Filippo Balestrieri, Palo Alto, CA (US); Cipriano A. Santos, Palo Alto, CA (US)

(73) Assignee: Hewlett Packard Enterprise Development LP, Houston, TX (US)

(21) Appl. No.: 15/033,036

(22) PCT Filed: Nov. 15, 2013
(86) PCT No.: PCT/US2013/070418

§ 371 Date: Apr. 28, 2016

(51) Int. Cl. G06Q 10/06; G06N 7/00

(52) U.S. Cl. CPC G06Q 10/06375; G06Q 10/0635; G06N 7/005

(57) ABSTRACT

An example method for selecting a task from a plurality of tasks is provided in accordance with an aspect of the present disclosure. The method includes transforming a probabilistic outcome of each task from a predetermined group of tasks to a reference outcome by replacing a probability distribution over values for each of a plurality of dimensions associated with the outcome of a task with a calculated value. The method also includes determining a subgroup of tasks from the predetermined group of tasks based on a comparison of the calculated values, using the calculated values to calculate a utility level for each of the tasks in the subgroup, and selecting a task among the subgroup of tasks.

### BACKGROUND

Organizations, businesses, and individuals often have to select between numerous different alternatives when making financially related decisions. In many situations, the alternatives offered to these organizations, businesses and individuals are so many (e.g., potentially uncountable) that a decision maker may have a difficult time to select what is the alternative that best fits his or her needs. In such complex situations, computer implemented tools may assist decision makers with refining their preferences and selecting the best possible alternative from the large pool of solutions that are offered to them.

### BRIEF DESCRIPTION OF THE DRAWINGS

FIG. 1 is a schematic illustration of an example of a system for selecting a task or solution from a plurality of tasks or solutions and for allocating resources among tasks in accordance with an implementation of the present disclosure.

FIG. 2 illustrates a flow chart showing an example of a method for selecting a task or solution from a plurality of tasks or solutions and for allocating resources among tasks in accordance with an implementation of the present disclosure.

FIG. 3 illustrates a flow chart showing an example of a method for transforming a probabilistic outcome of a task or solution to a reference outcome in accordance with an implementation of the present disclosure.

FIGS. 4, 4A, and 4B illustrate a flow chart showing an example of a method for selecting a task or solution among the subgroup of tasks or solutions used for allocating resources in accordance with an implementation of the present disclosure.

### DETAILED DESCRIPTION

As noted above, organizations, businesses, and individuals frequently have to select between a large number of different solutions or alternatives when they make financially related decisions. For example, there are many situations where decision makers must allocate a scarce resource (e.g., money, time, etc.) to different solutions or tasks (i.e., alternative courses of action) that may lead to different outcomes. Each of the possible solutions or tasks may be associated with different dimensions (e.g., goals or objectives) and may lead to a different outcome for the decision maker and/or the related business/organization.

Many times, manual comparison between all possible solutions or tasks available to a decision maker is unfeasible and very time consuming. This difficulty in selecting the best possible solution is due to the large number of possible alternatives, the specific dimensions defining the alternatives, internal rules and procedures the decision maker must follow, and his and her subjective preferences.

The difficulty in comparing multiple tasks or solutions and selecting the best possible task or solution becomes even greater when the environment that these tasks or solutions are in is stochastic and each of the alternatives is associated with a probabilistic outcome. Since most of the business environments today are stochastic (i.e., they include multiple possible outcomes/results for each task or solution), an improved process for allocating resources or selecting a specific solution between a large group of solutions becomes even more relevant.

One example of such selection process is when a marketing manager for a corporation must allocate a specific amount of marketing funds among a large number of marketing campaigns (e.g., 50, 500, 1000, etc.). Each of these marketing campaigns may have a different probabilistic outcome. In other words, the outcome of each task or solution is associated with a probability distribution over different values for each of the specific dimensions (e.g., goals, objectives, etc.) with respect to which the outcome is evaluated.

A decision maker (e.g., marketing manager) thus needs to be able to refine his or her preferences when selecting between the various available solutions or tasks in a stochastic environment. It is often desirable for a decision maker to identify the most preferred alternative (i.e., the alternative that best fits his or her needs and provides the best outcome) from the set of multiple available alternatives.

In many situations, determining the most preferred task or solution from the large number of stochastic alternatives may require going through all of the alternatives and analyzing their dimensions and outcomes manually. Alternatively, a scenario comparison or analysis tool that is less time consuming may be used. However, these tools only offer the possibility to compare a limited number of options that are arbitrary selected. The selected solution can be sub-optimal and with much lower level of decision accuracy because relevant options may be accidently neglected. When the decision maker's preferences are not fully predetermined, the limited number of comparisons of selection options offered to the decision maker may prevent the decision maker from identifying his or her preferences in the best possible way.

Consequently, computer implemented tools and methods may assist decision makers with refining their preferences and selecting the best possible solution from the large pool of solutions that are offered to them. Employing such computer implemented methods in a stochastic environment, where each task or solution is associated with a probabilistic outcome, is extremely difficult. As noted above, each possible task or solution (e.g., marketing campaign) is associated with an outcome that is defined by different dimensions (e.g., goals or objectives like profit, revenue, market share, etc.). However, in a stochastic environment, there is not a single output for each task or solution but a set of potential outputs. In other words, there is a probability distribution over the set of potential outputs and the dimensions associated with these outputs. In particular, there is a probability distribution over different values (e.g., monetary amounts, percentage increase, etc.) for each of the dimensions (e.g., there may be two possible outcomes for a single task: a 50% probability that a dimension (e.g., revenue) will increase 2%, and a 50% probability that the same dimension (e.g., revenue) will increase 4%, etc.).

The present description is directed to systems, methods, and computer readable media for allocating resources among tasks and for selecting a solution from a set of candidate solutions in a stochastic environment. Specifically, the systems, methods, and computer readable media described herein propose transforming the probabilistic outcome of each task to a reference outcome (i.e., an outcome that has one specific value associated with each of the dimensions) and defining the user's preferences for the plurality of tasks based on the reference outcome. Using an outcome that has a single value associated with each of its dimensions as opposed to a probability distribution for each of the plurality of dimensions allows for a much more efficient selection process of the user's preferred task or solution.

In one example, the probabilistic outcome of each task is transformed to a reference outcome by replacing the probability distribution over different values for each of the plurality of dimensions associated with the outcome of the task with a calculated value. The calculated value can be the certain equivalent for each dimension. The certain equivalent can be calculated by using a coefficient of risk aversion (e.g., relative risk aversion) associated with each dimension and an expected value for that dimension determined by a probability distribution over the values of that dimension.

Using the synthesized calculated values, a set of candidate solutions is determined and an initial best task or solution is identified based on the utility of each solution. “Take-it-or-leave-it” offers are used to elicit the preferences of the decision maker over the available dimensions and to select the best solution for allocating resources. These “take-it-or-leave-it” offers are used to elicit the preferences of the decision maker over the dimensions on the basis of which tasks or solutions are evaluated and over the risk associated with each dimension, and to help him or her to identify a final best solution by adjusting the coefficient of risk aversion of the decision maker. A final best solution is identified that is in accordance with the degree of risk aversion of the decision maker.

This approach allows decision makers to quickly and efficiently select from a large set of possible tasks or solutions that have probabilistic outcomes. The approach is applicable to a large set of resource allocation problems and can be used in many different industries. The approach imposes very light requirements on the decision makers and requires minimum input from them, which make it very attractive to users. The decision makers do not need to have ex-ante well defined preferences over the set of alternatives. The required initial inputs from the user are used for determining a starting point of the section, an initial temporary best solution that is later challenged and/or modified by a sequence of offers. Throughout the proposed process the decision maker is allowed to modify his or her initial preferences and adjust them in order to select a final best solution for allocation resources.

In an example implementation, a method for selecting a task among a plurality of tasks is provided. As with other methods described in this disclosure, the method can be performed by a computing device. For instance, a non-transitory machine-readable storage medium may store one or more computer programs or modules, which when executed by the computing device cause the method to be performed. The method includes transforming a probabilistic outcome of each task from a predetermined group of tasks to a reference outcome by replacing a probability distribution over values for each of a plurality of dimensions associated with the outcome of a task with a calculated value. The method also includes determining a subgroup of tasks from the predetermined group of tasks based on a comparison of the calculated values, using the calculated values to calculate a utility level for each of the tasks in the subgroup, and selecting a task among the subgroup of tasks.

In another example implementation, a system for selecting a solution from a set of candidate solutions is provided. The system includes at least one processor and a memory resource coupled to the processor. The memory resource stores instructions to direct the at least one processor to analyze an outcome for each solution from a predetermined set of solutions, where the outcome of each solution is associated with a probability distribution over values for each of a “n” number of dimensions with respect to which the outcome is evaluated. The memory resource also stores instructions to direct the at least one processor determine a calculated value representing each probability distribution over values for each of the “n” number of dimensions of each solution, and to define each solution from the predetermined set of solutions in relation to a reference outcome, where the probability distribution for each of the “n” number of dimensions of each solution is replaced with a calculated value. The memory resource further stores instructions to direct the at least one processor to determine a subset of solutions from the predetermined sets of solutions based on the calculated values, to calculate a utility level for each of the solutions in the subset of solutions by using the calculated values, and to select a solution among the subset of solutions.

As used herein, the terms “task,” “solution,” and “alternative” may be used interchangeably and refer to a plurality of different options that are available to organizations, businesses and individuals and are presented to them for a selection or for allocation of resources. It is to be understood that the methods and techniques described below may be used in a wide variety of industries and systems and may help a decision maker to make a selection among any type of possible tasks or solutions (e.g., business alternatives, consumer products, software systems or projects, etc.).

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

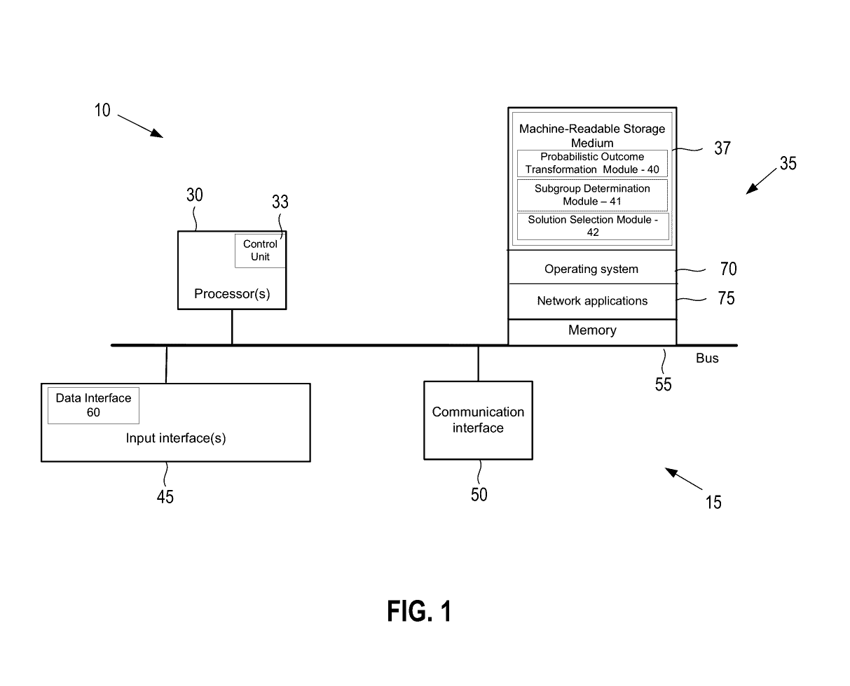

FIG. 1 is a schematic illustration of an example of a system 10 for selecting a task from a plurality of tasks and for allocating resources among tasks. The system 10 includes at least one computing device 15 capable of carrying out the techniques described below. The computing device 15 can be a personal computer, a laptop, a server, a mobile device, a plurality of distributed computing devices, or any other suitable computing device. In the illustrated example, the computing device 15 includes at least one processor 30, a memory resource 35, a communication interface 50, and input interface(s) 45.

As explained in additional detail below, the computing device 15 includes software, hardware, or a suitable combination thereof configured to enable functionality of the computing device 15 and to allow it to carry the techniques described below and to interact with the one or more external systems/devices. For example, the computing device 15 includes communication interfaces (e.g., a Wi-Fi® interface, a Bluetooth® interface, a 3G interface, a 4G interface, a near filed communication (NFC) interface, etc.) that are used to connect with external devices/systems (not shown) and/or to a network (not shown). The network may include any suitable type or configuration of network to allow for communication between the computing device 15 and any external devices/systems. It is to be understood that the operations described as being performed by the computing device 15 that are related to this description may, in some implementations, be performed by any other computing device.

The processor 30 (e.g., a central processing unit, a group of distributed processors, a microprocessor, a microcontroller, or another suitable programmable device), the memory resource 35, the input interfaces 45, and the communication interface 50 are operatively coupled to a bus 55. In other examples, the computing device 15 includes additional, fewer, or different components for carrying out similar functionality described herein.

The communication interface 50 enables the computing device 15 to communicate with a plurality of networks and communication links. The input interfaces 45 can receive information from any internal or external devices/systems in communication with the computing device 15. In one example, the input interfaces 45 include at least a data interface 60. In other examples, the input interfaces 45 can include additional interfaces. In one example, the data interface 60 receives information associated with a plurality of tasks or solutions that a user must evaluate and select from. For example, the data interface 60 can receive information regarding the outcome of each task or solution (e.g., a marketing campaign) that is associated with a plurality of dimensions (e.g., profit, revenue, market share, etc.) with respect to which the outcome is evaluated.

The processor 30 includes a controller 33 (also called a control unit) and may be implemented using any suitable type of processing system where at least one processor executes computer-readable instructions stored in the memory 35. The memory resource 35 includes any suitable type, number, and configuration of volatile or non-transitory machine-readable storage media 37 to store instructions and data. Examples of machine-readable storage media 37 in the memory 35 include read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, an SD card, and other suitable magnetic, optical, physical, or electronic memory devices. The memory 35 may also be used for storing temporary variables or other intermediate information during execution of instructions to be executed by processor 30.

The memory 35 may also store an operating system 70 and network applications 75. The operating system 70 can be multi-user, multiprocessing, multitasking, multithreading, and real-time. The operating system 70 can also perform basic tasks such as recognizing input from input devices, such as a keyboard, a keypad, or a mouse; sending an output to a projector and a camera; keeping track of files and directories on memory 35; controlling peripheral devices, such as printers and image capture devices; and managing traffic on the bus 55. The network applications 75 include various components for establishing and maintaining network connections, such as computer-readable instructions for implementing communication protocols including TCP/IP, HTTP, Ethernet, USB, and FireWire.

Software stored on the non-transitory machine-readable storage media 37 and executed by the processor 30 includes, for example, firmware, applications, program data, filters, rules, program modules, and other executable instructions. The control unit 33 retrieves from the machine-readable storage media 37 and executes, among other things, instructions related to the control processes and methods described herein. In one example, the instructions stored in the non-transitory machine-readable storage media 37 implement a probabilistic outcome transformation module 40, a subgroup determination module 41, and a solution selection module 42. In other examples, the instructions can implement more or fewer modules (e.g., various other modules related to the operation of the system 10).

As explained in additional detail below, the probabilistic outcome transformation module 40 transforms the probabilistic outcome of each task or solution to a reference outcome by replacing a probability distribution over values for each of a plurality of dimensions associated with the outcome of the task with a calculated value. The subgroup determination module 41 determines a subgroup of tasks or solutions from an initial group of tasks based on the comparison of the calculated values for the task or solutions. The solution selection module 42 identifies or selects a solution from the subgroup of tasks for allocating the resources among the subgroup of tasks based on a comparison of utility levels of the tasks.

Information and data associated with the system 10 and other systems/devices can be stored, logged, processed, and analyzed to implement the control methods and processes described herein. For example, the memory 35 may include at least one database (not shown) that is internal to the computing device 15. In other implementations, a database may be stored remotely of the computing device 15. In one example, information about the outcome of each task or solution and the plurality of dimensions associated with the outcome can be stored in the database.

As noted earlier, selection between a large number of different task or solutions in a stochastic environment is a frequent problem for many decision makers. The issue of what is the best way to allocate a scarce resource (e.g., money, time, etc.) among a plurality of tasks or solutions that have probabilistic outcomes is critical to many individuals and organizations.

Manual comparison between all available solutions or tasks is very time consuming because each task or solution may have a different probabilistic outcome that is defined by multiple dimensions, where the outcome is associated with a probability distribution over different values for these dimensions. Thus, a decision maker needs to efficiently refine his or her preferences in this stochastic environment in order to identify the most preferred solution from the set of available tasks or solutions. For instance, when a marketing manager must decide how to allocate a predetermined amount of marketing funds among a large number of marketing campaigns, she needs to be able to quickly sort through the available options and define which campaign best fits the needs of the company and/or her personal preferences. In that situation, each campaign has a different probabilistic outcome (i.e., it may produce different sets of rewards) that is defined by the different possible values of specific dimensions (e.g., profit, revenue, market share, etc.).

The techniques described below propose transforming the probabilistic outcome of each task to a reference outcome (i.e., an outcome that has one specific value associated with each of the dimensions) and using the reference outcome to define the user's preferences for the plurality of tasks. Specifically, the probabilistic outcome of each task is transformed to a reference outcome by replacing the probability distribution for each of the plurality of dimensions associated with the outcome of a task with a calculated value (e.g., the certain equivalent for each dimension). An initial solution is determined and “take-it-or-leave-it” offers are used to refine the preferences of the decision maker and to help him or her to identify a final best solution.

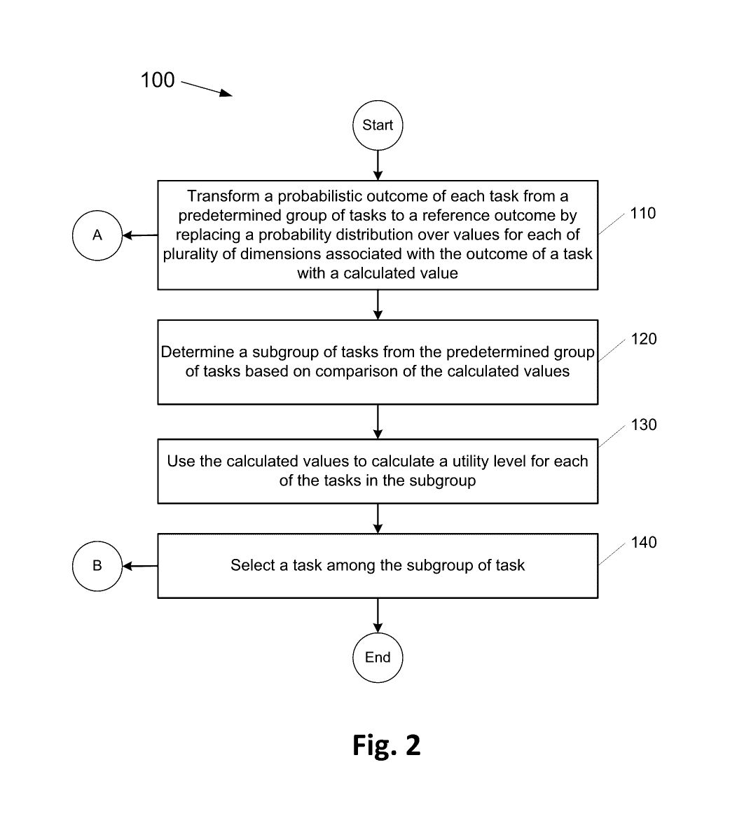

FIG. 2 illustrates a flow chart showing an example of a method 100 for selecting a task from a plurality of tasks and for allocating resources among tasks. In one example, the method 100 can be executed by the control unit 33 of the processor 30 of the computing device 15. Various steps described herein with respect to the method 100 are capable of being executed simultaneously, in parallel, or in an order that differs from the illustrated serial manner of execution. The method 100 is also capable of being executed using additional or fewer steps than are shown in the illustrated examples.

The method 100 may be executed in the form of instructions encoded on a non-transitory machine-readable storage medium 37 executable by processor 30 of the computing device 15. In one example, the instructions for the method 100 implement the probabilistic outcome transformation module 40, the subgroup determination module 41, and the solution selection module 42.

The method 100 begins at step 110, where the control unit 33 transforms a probabilistic outcome of each task from a predetermined group of tasks to a reference outcome. This can be done by the probabilistic outcome transformation module 40. As noted above, in one example, the described stochastic environment includes a plurality of tasks or solutions that have a different probabilistic outcome that is defined by specific dimensions, where the outcome is associated with a probability distribution over different values for these dimensions. Thus, each task or solution is associated with a set of probability distributions (i.e., for the corresponding “n” number of dimensions) and each element of the set is a probability distribution with respect to one dimension. Instead of specific values for all dimensions, the stochastic environment presents a probability distribution over different values for all dimensions. In one implementation, the control unit 33 transforms the probabilistic outcome of each task from a predetermined group of tasks to a reference outcome by replacing the probability distribution for each of the plurality of dimensions associated with the outcome of a task with a calculated value.

In the example described above, the tasks or solutions may be a group of marketing campaigns, where each campaign has a different probabilistic outcome that is defined by a plurality of dimensions (e.g., revenue, profit, market share, etc). In other words, each of the marketing campaigns may produce a set of outcomes that are defined by the probability distribution of the specific dimensions (e.g., there is a 50% probability that campaign A will produce a +3% increase in revenue, a +1% increase in profit, and a +2% increase market share; there is a 50% probability that campaign A will produce a +1% increase in revenue, a +3% increase in profit, and a +1% increase market share, etc.). Therefore, the outcome for each task may include a number of different values for each dimension.

In one example, an initial set of feasible tasks or solutions (i.e., marketing campaigns) is predefined and is available to the decision maker for selection and/or allocation. Based on inputted constraints, a group of probabilistic outcomes and values for the dimensions associated with each task or solution are also predefined. For instance, given some specific constraints (e.g. at most a level “x” of resource can be allocated to task “A”), a set of feasible tasks or solutions that satisfy an constraints is identified. This identification of stochastic tasks or solutions can be completed by the decision maker, her manager, another person in the organization, a third party, or in any other suitable way. The predetermined set of tasks or solutions may be stored in a database of the computing device 15, in an external database, in the cloud, etc. Considering the example above, a group or a set of all possible combinations of marketing campaigns that satisfy some constraints and can be possibly funded with the resources (e.g., $100) is identified. The number and nature of the tasks and their dimensions may be industry specific. Dimensions can vary depending on the type of assets being allocated, the objectives, and the overall goal of the allocation project. The tasks or solutions may be products, services, projects, or anything that may conceivably be a subject to choices or preferences associated with the decision maker.

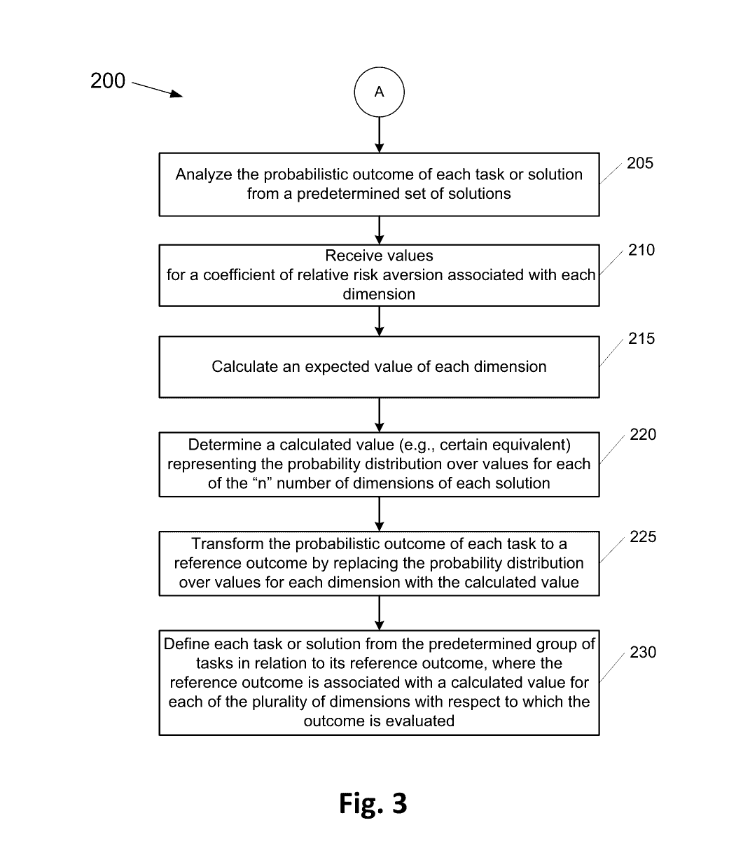

FIG. 3 illustrates a flow chart showing an example of a method 200 for transforming a probabilistic outcome of a task or solution to a reference outcome. In one example, the method 200 can be executed by the control unit 33 of the processor of the computing device 15. Various steps described herein with respect to the method 200 are capable of being executed simultaneously, in parallel, or in an order that differs from the illustrated serial manner of execution. The method 200 may be executed in the form of instructions encoded on a non-transitory machine-readable storage medium 37 executable by the processor 30.

The method 200 begins at step 205, where the control unit 33 analyzes the probabilistic outcome of each task or solution from the predetermined set of solutions, where the outcome of each solution is associated with a probability distribution over values for each of “n” number of dimensions with respect to which the outcome is evaluated. As explained in additional details below, the control unit 33 determines a calculated value that represents the probability distribution over values for each of the “n” number of dimensions of each solution. Further, the control unit 33 defines each task or solution from the predetermined set of solutions in relation to its reference outcome, where the probability distribution for each of the “n” number of dimensions of each solution is replaced with a calculated value. In one implementation, the number “n” is at least two. In other words, the outcome for each task or solution is associated with at least two dimensions. Therefore, each of the tasks is defined in terms of its outcome that includes the calculated value (i.e., certain equivalent) for each dimension.

As explained in additional details below, the control unit calculates a value (e.g., a certain equivalent value) for each of the “n” number of dimensions of each task or solution. As mentioned above, in one implementation, the control unit 33 transforms the probabilistic outcome of each task from the predefined group of tasks to a reference outcome by replacing the probability distribution over values for each of the plurality of dimensions associated with the outcome of a task with a calculated value. For instance, the function U described below may be used to calculate a value (e.g., certain equivalent) for each dimension associated with the stochastic outcome for each task or solution. In one example, the function is:

$${U}_{i}^{{γ}_{i}} ( {x}_{i} ) = \frac{{x}_{i}^{1 - {γ}_{i}}}{1 - {γ}_{i}}$$

where i represents a dimension (e.g., revenue, profit, market share, etc.) associated with the outcome for each task or solution; xᵢ represents a value associated with that dimension (e.g., a revenue level); and γᵢ≧0 is a coefficient of risk aversion associated with each dimension (e.g., coefficient of relative risk aversion). It is to be understood that various other functions associated to measures of risk aversion (e.g., absolute risk aversion, etc.) may also be used in place of function U in the described process although relative risk aversion may be used as an example in the description below. As described in additional details below, the function U is used to determine a calculated value representing each probability distribution over values for each of the “n” number of dimensions of each solution and thus to transform the probabilistic outcome of each task from the predetermined group of tasks to a reference outcome.

At step 210, the control unit 33 receives values γᵢ for the coefficient of relative risk aversion associated with each dimension. The values for the coefficient of relative risk aversion associated with each dimension may be received from the decision maker. In one example, the decision maker is asked to provide an indication of her or his risk aversion with respect to the different dimensions associated with the outcome (e.g., very risk averse in relation to profit, more risk neutral in relation to revenue, etc.). In one implementation, the decision maker may indicate the degree of risk aversion γᵢ of the different dimensions by placing predetermined numbers (e.g., 1-n) to each of the dimensions (e.g., γ₁=1; γ₂=2; γ₃=3). If γ₁=1, then U₁¹(x)=ln x. In other words, the limit of the function U for gamma approaching one is the natural logarithm, The higher the number is, the greater the risk aversion is associated with that dimension (e.g., ranking γ₃ with 3 means that a user is less inclined to take a risk related to that dimension as compared to a dimension ranked with 2 or 1). In other implementations, different methods for determining the degree of risk aversion of the different dimensions γᵢ may be used (e.g. an appropriately designed survey or questionnaire). Default or predetermined values for the degree of risk aversion may also be used (e.g., when the decision maker does not provide any direct input).

In one example, a value of zero for γᵢ corresponds to risk neutrality. Also, higher value of γᵢ represents that the decision maker is more risk averse. Negative values of γᵢ describes risk-seeking behavior. As explained in additional details below, the degree of risk aversion parameter may be automatically updated during the execution of the method 200.

At step 215, the control unit 33, calculates an expected value of each dimension. As noted earlier, each task or solution generates an outcome that is defined by different values for each of the dimensions associated with the outcome. When the values for the relative degree of risk aversion γᵢ are determined, the control unit 33 proceeds with replacing the probability distribution for each of the plurality of dimensions associated with the outcome of a task with a calculated value (e.g., the certain equivalent value). In one example, the certain equivalent value for a dimension is calculated by using the coefficient of relative risk aversion γᵢ associated with the dimension being considered and an expected value for that dimension determined by a probability distribution over the values of that dimension. In other words, for each of the dimensions associated with an outcome, the control unit 33 calculates the certain equivalent value, which for the decision maker is an equivalent to replace all other available values for that dimension.

For example, based on values for the relative degree of risk aversion γᵢ, a certain equivalent “space” (e.g., γᵢ, γᵢ) for each task or outcome is identified. Each task or solution is associated with a probability distribution over values xᵢ for each of the dimensions. With reference to one example, task A (i.e., marketing campaign A) may generate an outcome (fᵢ^{A}, fⱼ^{A}), where each function fᵢ^{A} is a probability distribution function over values xᵢ. For instance, task A may include a 50% probability that the revenue will increase with 2%, and a 50% probability that the revenue will increase with 1%. The weighted addition of the probability distribution function over the values provides the expected value of each dimension. In one example, the expected value of each dimension is calculated by multiplying the value of each instance (e.g., 2% increase) to the probability of this instance to occur (e.g., 50%) and adding the multiple possibilities to obtain the expected level for that dimension (e.g., (0.5×0.02)+(0.5×0.01)=0.015). As noted above, the probabilities and the values of xᵢ are predetermined. The calculated expected value of each dimension is used with the parameters of the function U to determine the certain equivalent value for each dimension for each task or solution.

Next, the control unit 33 determines a calculated value (e.g., certain equivalent) representing the probability distribution for each of the “n” number of dimensions of each solution (at step 220). In one example, the control unit 33 calculates the certain equivalent for each dimension i associated with each task or solution as follows:

Uᵢ^{γ}^{ᵢ}(\tilde{x}ᵢ^{A})=∫xᵢ^{A}fᵢ^{A}dxᵢ^{A} (Eq. 1)

The left side of the Equation 1 represents the function U for the dimension i determined by the given value for the degree of risk aversion γᵢ (e.g., the relative degree of risk aversion), and the right side of the equation represents the expected value for the dimension i. In other words, the certain equivalent value \tilde{x}ᵢ^{A} for a task or solution A with respect to dimension is the value of \tilde{x}ᵢ^{A} such that \tilde{x}ᵢ^{A} satisfies the Equation 1 above. Thus, considering the values for the relative degree of risk aversion γᵢ, the control system 33 determines which of the multiple values of \tilde{x}ᵢ^{A} for that dimension produces a value for \tilde{x}ᵢ^{A} that is equivalent to the expected value (e.g., 0.015). The value of that produces the same result as the expected value is the calculated certain equivalent value for that dimension. In some examples, each value xᵢ may be transformed into its corresponding percentage change by comparing xᵢ to the status quo

$$\frac{{x}_{i} - {x}_{i}^{*}}{{x}_{i}^{*}}$$

for any dimension i, where status quo level xᵢ* represents a value for any dimension i during a previous time frame (e.g., the previous fiscal year). It is to be understood that this transformation is performed before the certain equivalent is calculated and before the rest of the steps of the process are executed.

Therefore, by replacing the probability distribution over values for each of the “n” number of dimensions associated with the outcome of a task with a calculated value (i.e., the certain equivalent value), the control unit 33 transforms the probabilistic outcome of each task from a set of probability distributions over different values (i.e. one probability distribution for each dimension) to a reference outcome (at step 225). Then, the control unit 33 defines or maps each task or solution from the predetermined group of tasks in relation to its reference outcome, where the reference outcome is associated with a calculated value for each of the plurality of dimensions with respect to which the outcome is evaluated (at step 230). Thus, the control unit 33 defines or maps each task or solution from the group of predetermined tasks into a certain equivalent “space”. In other examples, the control unit may use a different calculated value (the average value, the maximum value, or minimum value of the probability distribution, etc.) to transform the probabilistic outcome of each task to a reference outcome. However, by using the certain equivalent value the method keeps track of both the characteristics of the probability distribution over different values for all dimensions and the attitude toward risk of the decision maker.

With continued reference to FIG. 2, the control unit 33 determines, at step 120, a subgroup of tasks or solutions from the predetermined group of tasks or solutions based on comparison of the calculated values (i.e., certain equivalents) associated with each task or solution and/or additional parameters for each dimension (e.g. minimum/maximum value of each probability distribution for each dimension, etc.). In other words, the control unit 33 uses the calculated value and/or additional parameters that are associated with the probability distribution for each of the “n” number of dimensions of each task or solution to determine a subset of solutions from the predetermined sets of solutions. This can be done by the subgroup determination module 41. In one example, the control unit 33 classifies the task or solutions as dominated and dominating tasks and identifies a Pareto efficient subgroup of tasks or solutions for further analysis based on the comparison of certain equivalents. It is to be understood that a Pareto efficient subgroup may exist for each specific combination of values of the coefficient of relative risk aversion (i.e., each value of γᵢ produces different sets of certain equivalent values for the tasks or solutions). In another example, different properties of the tasks or solutions (in addition to or alternatively to Pareto efficiency) may be used to classify the tasks or solutions and to determine a subset.

Various methods can be used to identify a Pareto efficient subset of tasks or solutions from the initial predetermined group of tasks or solutions. In one example, a Pareto dominated task is defined as a task where the control unit 33 can identify another task from the initial group of tasks that is superior with respect to the certain equivalent values for all dimensions associated with the outcome of the first task. In the example above, there may be three possible tasks—campaign A that produces certain equivalents of +3% increase in revenue, +1% increase in profit, and +2% increase market share; campaign B that produces certain equivalents of +1% increase in revenue, +3% increase in profit, and +1% increase in market share; and campaign C that produces certain equivalents of +0.5% increase in revenue, +0.5% increase in profit, and +0.5% increase in market share. In that example, campaign C is Pareto dominated, whereas campaigns A and B are both Pareto dominating (i.e.., none of them is dominated and they both will be included in the Pareto efficient set). The end result of step 120 is a subgroup or subset of Pareto dominating tasks that satisfy all constraints of the predetermined set and are identified based on the calculated certain equivalent values for their dimensions.

At step 130, the control unit 33 uses the calculated values (i.e., the certain equivalents) for the dimensions to determine a utility level for each of the tasks in the subgroup. For example, this is done with a utility function by the utility level determination module 41. Using the calculated values as input, various methods or functions can be implemented to calculate a utility level for all tasks in the subset of tasks or solutions. The utility level of each task or solution may be represented by a numerical value. Thus, the utility level of each task or solution is a function of the multiple dimensions (e.g., profit, revenue, market share, etc.) associated with the outcome of each task, where each dimension is associated with the previously calculated certain equivalent value.

In one implementation, the control unit 33 inputs a plurality of parameters into a utility function, where one of the parameters is the calculated value for each dimension associated with the outcome for each task. Other parameters in the utility function may include the relative importance of each dimension i with respect to the other dimensions associated with the outcome of the task, and an elasticity of substitution that quantifies the degree of flexibility with which a user (i.e., the decision maker) is willing to trade one dimension with another to maximize the utility by selecting a different task or solution. The values for the relative importance of a dimension i with respect to the other dimensions may be received from the decision maker. In another example, default or predetermined values for the relative importance of the dimensions may be used (e.g., when the decision maker does not provide any direct input). The control unit 33 calculates the utility level of each task from the subgroup of tasks based on the plurality of parameters in the utility function.

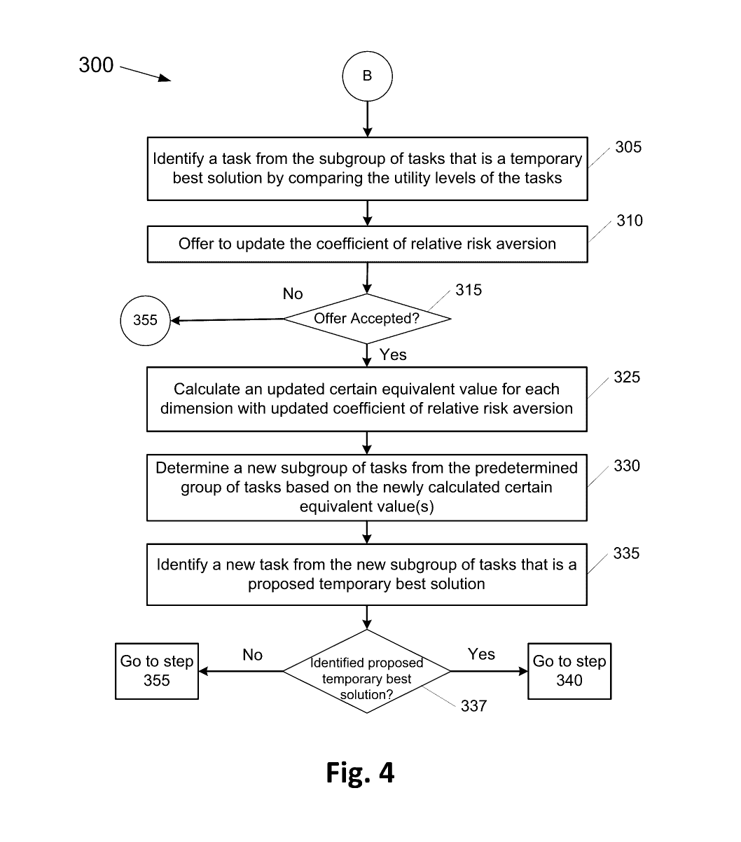

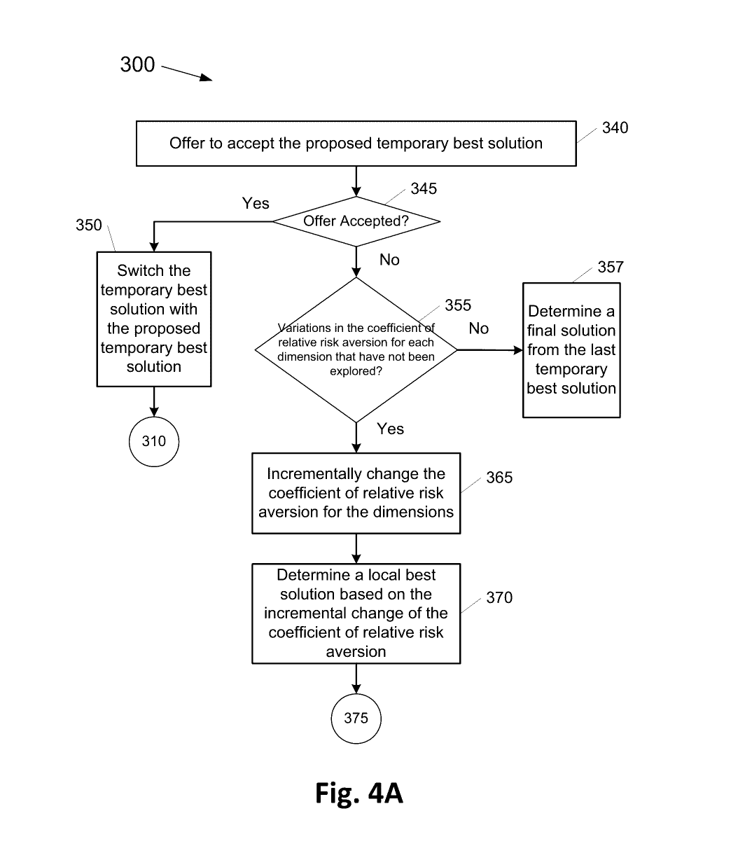

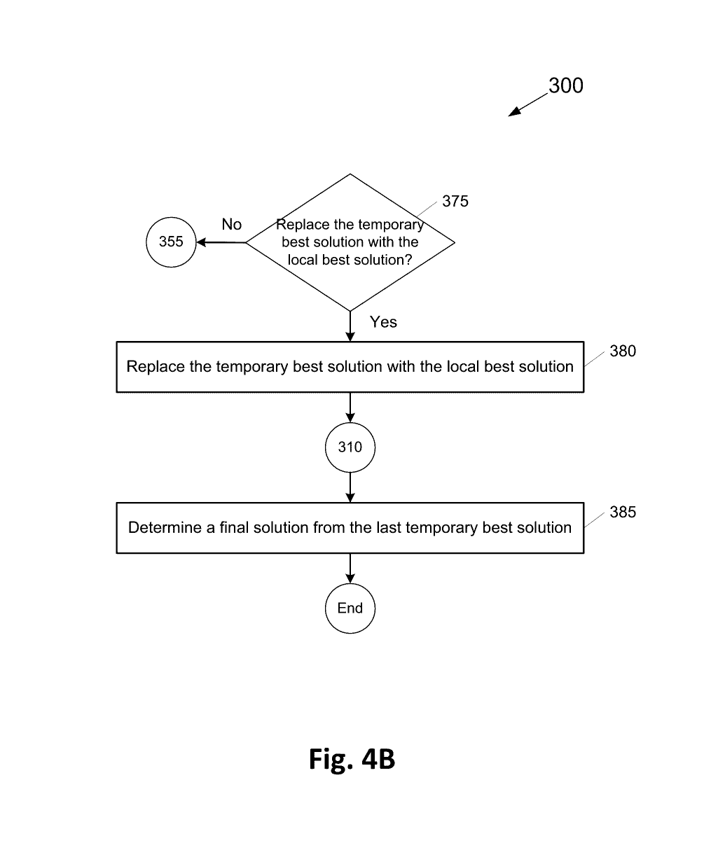

Next, the control unit 33 selects a task among the subgroup of tasks (at step 140). In other words, the control unit selects a task or solution to which to allocate the available resources. For example, this is done by the solution selection module 42. As explained in additional details below with relation to FIGS. 4-4B, the control unit 33 identifies a task among the subgroup of tasks that is defined as a temporary best solution that is offered to the decision maker. Based on the response of the decision maker and his or her willingness to update the coefficient of relative risk aversion, the control unit 33 may calculate updated certain equivalent values and use them to identify alternative tasks or solutions to offer to the decision maker. At the end, the decision maker selects a final task or solution that may be used to allocate resources among the different tasks or solutions.

FIGS. 4-4B illustrate a flow chart showing an example of a method 300 for selecting a task or solution among the subgroup of tasks, where that task or solution is used for allocating resources. In one example, the method 300 can be executed by the control unit 33 of the processor of the computing device 15. Various steps described herein with respect to the method 100 are capable of being executed simultaneously, in parallel, or in an order that differs from the illustrated serial manner of execution. The method 200 may be executed in the form of instructions encoded on a non-transitory machine-readable storage medium 37 executable by the processor 30.

The method 300 begins at step 305, where the control unit 33 identifies a task or solution from the subgroup of tasks that is a temporary best solution by comparing the utility levels of the tasks. As noted above, in one example, the control unit 33 calculates a utility level of each task from the subgroup of tasks based on the plurality of parameters in the utility function and identifies a task from the subgroup of tasks that is a temporary best solution. In one implementation, the temporary best solution is identified by comparing the utility levels of the tasks, where the task or solution with the highest utility level is identified as the temporary best solution. This is the first task or solution from the subset of tasks or solutions that may be offered to the decision maker as the final solution to select a task from the subgroup of tasks.

In other examples, alternative selection methods or scenario analysis tools may be used to identify a temporary best solution. These methods or tools may use the calculated certain equivalent value for each task or solution as a definite input value in their calculation process.

After the temporary best solution is presented to the decision maker, at step 310, the control unit 33 offers to the decision maker to update the coefficient of relative risk aversion γᵢ. In other words, the system evaluates the possibility that the decision maker may want to explore different degrees of risk exposure with respect to any of the dimensions. In this way, the proposed method tests the elasticity of risk-substitution of the decision maker across the different dimensions associated with the outcomes of the tasks or solutions. In one example, the control unit displays a message on a display screen (not shown) of the computing device 15 or another computing device operated by the user in order to relay the offer to the user. Other suitable methods for communicating the offer to the decision maker may also be used.

The decision maker may either reject or accept the offer to the coefficient of risk aversion γᵢ (e.g., relative risk aversion). The user can provide his or her response by using an input device (e.g., a keyboard, a voice activate input, etc.) or any other suitable way of providing a response to the control unit 33. In step 315, the control unit 33 determines what is the user's response regarding the offer. If the user rejects the offer, the control unit moves to step 355 to determine whether there are variations in the coefficient of relative risk aversion for each dimension that have not been explored by the user, and to determine a local best solution (described in additional detail below). If the user accepts the offer and updates the coefficient of relative risk aversion γᵢ for at least one of the dimensions, the control unit 33 calculates an updated certain equivalent value for each dimension with an updated coefficient of relative risk aversion γᵢ (at step 325). In one example, the decision maker may only update the coefficient of relative risk aversion γᵢ for one of the dimensions. Alternatively, the coefficient of relative risk aversion may be updated for all of the dimensions. Based on the newly calculated certain equivalent value(s) for the dimensions associated with each task or solution, the control unit 33 determines a new subgroup of tasks (e.g., Pareto efficient set as described above) from the original predetermined group of tasks (at step 330).

At step 335, the control unit identifies a new task or solution from the new subgroup of tasks or solutions that is a proposed temporary best solution. In other words, the system analyzes the new subgroup of tasks or solutions based on the updated input from the decision maker that clarifies his or her preferences (i.e., the coefficient of relative risk aversion γᵢ), and determines if there is a better solution based on the updated user preferences. Thus, the previously identified temporary best solution may no longer be the best possible solution for the user. In one example, the proposed temporary best solution is determined by inputting the updated certain equivalent values into the utility function, determining a utility level of the new subgroup of tasks, and comparing the new utility levels of the tasks. As discussed above, other methods for determining the proposed temporary best solution may be used.

In some examples, the proposed temporary best solution generates an outcome with dimensions and values that are different (i.e., higher or lower) from the values of the dimensions in the temporary best solution. In other implementations, the task associated with the temporary best solution identified at step 305 may be the best possible solution based on the new certain equivalent value(s) calculated by the system. In that situation, even when the coefficient of relative risk aversion is updated, the control unit 33 may not identify a proposed temporary best solution and may move to identifying a local best solution (explained in additional details below).

At step 337, the control unit 33 determines if a proposed temporary best solution is identified (i.e., whether there is a new task or solution from the new subgroup of tasks or solutions that may be a better solution). If such proposed temporary best solution is identified, the control unit proceeds with step 340 where it offers to the decision maker to accept the proposed temporary best solution (described in additional details below). If no temporary best solution is identified to challenge the standing temporary best solution (i.e., when the task associated with the temporary best solution identified at step 305 is selected as the best possible solution), the control unit 33 directly proceeds with step 355 to determine a local best solution (also described in additional details below).

When a proposed temporary best solution is identified (at step 335), the control unit 33 offers to the decision maker to switch from the previously identified temporary best solution and to accept the proposed temporary best solution (at step 340). In one implementation, the proposed temporary best solution is only offered to the user if it was not offered at a previous offering. For example, the control unit displays a message on a display screen (not shown) of the computing device 15 or another computing device operated by the user. In one implementation, the control unit 33 shows the differences between the proposed temporary best solution and the previously identified temporary best solution (e.g., the differences with respect to each dimension (i.e., gain/loss) that are associated with switching from one task or solution to another).

The decision maker may either reject or accept the offer to switch from the previously identified temporary best solution to the proposed temporary best solution. The user can provide his or her response by using an input device (e.g., a keyboard, a voice activate input, etc.) or any other suitable way of providing a response to the control unit 33. In step 345, the control unit 33 determines what is the user's response regarding the offer. If the user accepts the offer to switch from the previously identified temporary best solution to the proposed temporary best solution, the control unit 33 switches the temporary best solution with the proposed temporary best solution (at step 350). In that case, the proposed temporary best solution becomes a new temporary best solution. Next, the control unit 33 returns to step 310 where it offers the decision maker to update the coefficient of relative risk aversion. That way, the control unit 33 continues to offer new proposed temporary based solutions for the user's consideration in order to best identify the user's preferences over the dimensions with respect of which each task or solution is evaluated, to best identify the user's preferences towards risk, and to help the user to select the best possible task or solution from the subgroup of solutions. The process described in steps 340, 345, and 350 is repeated until no new proposed temporary best solution is identified to challenge the standing temporary best solution. In that case, the control unit 33 proceeds to step 370 to determine a local best solution that is offered to the decision maker (described in additional details below).

If the user rejects the offer to switch from the previously identified temporary best solution to the proposed temporary best solution, the control unit 33 proceeds to determine a local best solution that is offered to the decision maker. In one example, the control unit 33 analyzes the temporary best solution to determine whether there are variations in the coefficient of relative risk aversion for each dimension that have not been explored by the user (at step 355) throughout the overall process. If there are no variations in the coefficient of relative risk aversion for the dimensions that have not been explored, the control unit 33 identifies the task associated with the last temporary best solution as the final task or solution to be selected from the subgroup of tasks (at step 357) to select a task or solution from the subgroup of tasks. This selected task or solution may be used to allocate the resources available to the decision maker.

If there are variations in the coefficient of relative risk aversion for at least one of the dimensions that have not been explored, the control unit 33 incrementally changes the coefficient of relative risk aversion for these dimensions (at step 365). In other words, the control unit slightly modifies the coefficient of relative risk aversion for these dimensions in a direction not previously modified (e.g., up or down). If the coefficient of relative risk aversion for a dimension was never modified, the direction of change may be randomly determined. Then, the control unit determines a local best solution based on the incremental change of the coefficient of relative risk aversion (at step 370). For example, the control unit 33 returns to step 325 to calculate an updated certain equivalent value for each dimension with an updated coefficient of relative risk aversion and to identify a new task from the new subgroup of tasks that is the local best solution. The differences between the local best solution and the temporary best solution (e.g., gain/loss of dimension, increment/decrement in the risk associated to a dimension, etc.) may be displayed for the user.

Next, the control unit 33 offers to the decision maker to replace the temporary best solution with the local best solution (at step 375). If the decision maker rejects the local best solution, the control 33 returns to step 355 to determine whether there are any remaining variations in the coefficient of relative risk aversion for each dimension that have not been explored by the user. If there are, steps 365-375 are executed again.

If the decision maker accepts the local best solution, the control unit 33 replaces the temporary best solution with the local best solution (at step 380). In that case, the local best solution becomes a new temporary best solution. Next, the control unit 33 returns to step 305 where it offers the decision maker to update the coefficient of relative risk aversion. The process described in steps 355-380 is repeated until no new proposed temporary and local best solution is identified and the temporary best solution accepted by the user is identified as the final solution (at step 385) to select a task or solution from the subgroup of tasks.

What is claimed is:

1. A method for selecting a task from a plurality of tasks, the method comprising:
transforming, with a computing device, a probabilistic outcome of each task from a predetermined group of tasks to a reference outcome by replacing a probability distribution over values for each of a plurality of dimensions associated with the outcome of a task with a calculated value;
determining, with the computing device, a subgroup of tasks from the predetermined group of tasks based on a comparison of the calculated values;
using the calculated values to calculate, with the computing device, a utility level for each of the tasks in the subgroup; and
selecting, with the computing device, a task among the subgroup of tasks.

2. The method of claim 1, wherein the calculated value for each dimension associated with the outcome of each task is a certain equivalent value that is calculated, with the computing device, by using a coefficient of risk aversion associated with each dimension and an expected value of that dimension determined by a probability distribution over all values of the dimension.

3. The method of claim 2, wherein transforming the probabilistic outcome of each task to a reference outcome comprises:
analyzing the probabilistic outcome of each task from the predetermined group of solutions,
receiving values for the coefficient of risk aversion associated with each dimension,
calculating the expected value of each dimension,
determining a calculated value representing the probability distribution over values for each of the plurality of dimensions associated with the outcome of each task, and
transforming the probabilistic outcome of each task to a reference outcome by replacing the probability distribution over values for each dimension with the calculated value.

4. The method of claim 3, further comprising defining, with the computing device, each task from the predetermined group of tasks in relation to its reference outcome, wherein the reference outcome is associated with a calculated value for each of the plurality of dimensions with respect to which the outcome is evaluated.

5. The method of claim 2, wherein selecting a task among the subgroup of task comprises:
inputting, with the computing device, a plurality of parameters into a utility function, wherein one of the parameters is the calculated value for each dimension associated with the outcome for each task,
calculating, with the computing device, the utility level of each task from the subgroup of tasks based on the plurality of parameters in the utility function, and
identifying, with the computing device, a task from the subgroup of tasks that is a temporary best solution by comparing the utility levels of the tasks.

6. The method of claim 5, wherein selecting a task among the subgroup of task further comprises:
updating, with the computing device, the coefficient of risk aversion,
calculating, with the computing device, an updated certain equivalent value for each dimension with an updated coefficient of risk aversion,
determining, with the computing device, a new subgroup of tasks from the predetermined group of tasks based on the updated certain equivalent value,
identifying, with the computing device, a new task from the new subgroup of tasks that is a proposed temporary best solution, and
offering to switch the temporary best solution with the proposed temporary best solution.

7. The method of claim 6, wherein selecting a task among the subgroup of task further comprises:
incrementally changing, with the computing device, the coefficient of risk aversion for each dimension,
determining, with the computing device, a local best solution based on the incremental change of the coefficient of risk aversion,
offering, with the computing device, to accept the proposed local best solution,
rejecting, with the computing device, the local best solution,
accepting, with the computing device, the local best solution,
replacing, with the computing device, the proposed temporary best solution with the local best solution when the offer to accept the local best solution is accepted, and
determining, with the computing device, a final solution to select a task from the subgroup of tasks.

8. A system for selecting a solution from a set of candidate solutions, the system comprising:
at least one processor; and
a memory resource coupled to the at least one processor and storing instructions to direct the at least one processor to:
analyze an outcome of each solution from a predetermined set of solutions, wherein the outcome of each solution is associated with a probability distribution over values for “n” number of dimensions with respect to which the outcome is evaluated,
determine a calculated value representing the probability distribution over values for each of the “n” number of dimensions of each solution,
define each solution from the predetermined set of solutions in relation to a reference outcome, where the probability distribution over values for each of the “n” number of dimensions of each solution is replaced with a calculated value,
determine a subset of solutions from the predetermined sets of solutions based on the calculated values,
calculate a utility level for each of the solutions in the subset of solutions by using the calculated values, and
select a solution among the subset of solutions.

9. The system of claim 8, wherein the calculated value is a certain equivalent, and wherein the certain equivalent value for each dimension associated with the outcome for each solution is calculated by using a coefficient of risk aversion associated with each dimension and an expected value of that dimension determined by a probably distribution over all values of the dimension.

10. The system of claim 9, wherein the memory resource further stores instructions to direct the at least one processor to:
calculate the utility level of each solution from the subset of solutions with a utility function, wherein one of the parameters in the utility function is the calculated value for each dimension,
identify a temporary best solution from the subset of solutions by comparing the utility levels of the solutions,
update the coefficient of risk aversion,
calculate an updated calculated value for each dimension with an updated coefficient of risk aversion,
determine a new subset of solutions from the predetermined set of solutions based on the updated calculated values,
identify a proposed temporary best solution from the new subset of solutions by inputting the updated calculated values into the utility function, and
offer to switch the temporary best solution with the proposed temporary best solution.

11. The system of claim 10, wherein the memory resource further stores instructions to direct the at least processor to:
modify the coefficient of risk aversion in a direction not previously modified,
identify a local best solution based on the modification of the coefficient of risk aversion,
propose to substitute the temporary best solution with the proposed local best solution,
reject the proposed local best solution when the proposal is not accepted,
switch the proposed temporary best solution with the local best solution when the proposal is accepted, and
select a final solution.

12. A non-transitory machine-readable storage medium encoded with instructions executable by at least one processor of a system for allocating resources among tasks, the machine-readable storage medium comprising instructions to:
analyze a group of tasks, each task being associated with a probabilistic outcome;
replace a probability distribution over values for each of a plurality of dimensions associated with the outcome of a task with a certain equivalent value that is calculated by using a coefficient of risk aversion associated with each dimension of a task and an expected value of that dimension determined by a probability distribution over all values of the dimension;
determine a subgroup of tasks from the group of tasks based on the certain equivalent values;
determine a utility level for each of the tasks in the subgroup of tasks by using the certain equivalent values; and
identify a solution for allocating the resources among the subgroup of tasks.

13. The non-transitory machine-readable medium of claim 12, further comprising instructions to:
receive values for the coefficient of risk aversion associated with each dimension,
calculate the expected value of each dimension,
determine a certain equivalent value representing the probability distribution over values for each of the plurality of dimensions associated with the outcome of each task,
transform the probabilistic outcome of each task from to a reference outcome by replacing the probability distribution over values for each dimension the certain equivalent value, and
define each task from the group of tasks in relation to its reference outcome.

14. The non-trans y machine-readable medium of claim 13, further comprising instructions to:
calculate the utility level of each task from the subgroup of tasks with a utility function,
identify a task from the subgroup of tasks that is a temporary best solution by comparing the utility levels of the tasks in the subgroup of tasks,
update the coefficient of risk aversion,
calculate an updated certain equivalent value for each dimension with updated
coefficient of risk aversion,
determine a new subgroup of tasks from the predetermined group of tasks based on the updated certain equivalent values,
identify a task from the new subgroup of tasks that is a proposed temporary best solution, and
offer to switch the temporary best solution with the proposed temporary best solution.

15. The non-transitory machine-readable medium of claim 14, further comprising instructions to
incrementally change the coefficient of risk aversion,
determine a local best solution based on the incremental change of the coefficient of risk aversion,
offer to accept the proposed local best solution,
reject the local best solution,
switch the proposed temporary best solution with the local best solution when the offer to accept the local best solution is accepted, and
determine a final solution for allocating the resources among the subgroup of tasks.
